(19) United States
(12) Patent Application Publication
(10) Pub. No.: US 2014/0347151 A1
(43) Pub. Date: Nov. 27, 2014

(54) SWITCHING DEVICE SUITABLE FOR DIRECT-CURRENT OPERATION

(71) Applicant: EATON ELECTRICAL IP GMBH & CO. KG, Schöenefeld (DE)

(72) Inventors: Karsten Gerving, Bonn (DE); Volker Lang, Bonn (DE); Johannes Meissner, Bonn (DE); Ralf Thar, St. Augustin (DE); Guido Dedenbach, Bonn (DE)

(73) Assignee: EATON ELECTRICAL IP GMBH & CO. KG, Schoenefeld (DE)

(21) Appl. No.: 14/360,946

(22) PCT Filed: Nov. 28, 2012
(86) PCT No.: PCT/EP2012/073792

§ 371 Date: May 28, 2014

(30) Foreign Application Priority Data
Nov. 29, 2011 (EP) 11191216.8

(51) Int. Cl. H01H 33/04

(52) U.S. Cl. CPC H01H 33/04
USPC 335/205

(57) ABSTRACT

A switching device having a housing; a first and second contact, at least one of the contacts movable, both in contact when switched-on and not in contact when switched-off; an arc driver assembly producing a magnetic field at least in the area of the contact pair; a first arc conducting assembly which produces an arc between the contacts in a first current direction conducted to a first quenching apparatus for quenching the arc; and a second arc conducting assembly which produces an arc between the contacts with a second current direction opposite the first current direction conducted to a second quenching apparatus, the two arc conducting assemblies each comprising at least two conducting plates, of which at least a first is immovably in the housing and a second is connected at least partially rigidly to a bridge assembly and is movably arranged in the housing.

### CROSS-REFERENCE TO RELATED APPLICATIONS

This application is a U.S. National Stage application under 35 U.S.C. §371 of International Application No. PCT/EP2012/073792 filed on Nov. 28, 2012, and claims benefit to European Patent Application No. EP 11191216.8 filed on Nov. 29, 2011. The International Application was published in German on Jun. 6, 2013, as WO 2013/079508 A1 under PCT Article 21(2).

### FIELD

The invention relates to a switching device for direct current operation.

### BACKGROUND

Such a switching device is known from EP2 061 053 A2. For creating a switching device for direct current applications, it is recommended that the housing of a switching device for alternating current applications be used, where at least one additional magnet is provided for creating a magnetic field with field lines predominantly transverse to the isolation gaps of current paths of the alternating current switching device. There are three receiving regions in the housing for each single current path, where each current path is assigned a movable switching contact element as well as two fixed switching contact elements opposite to each other. The three movable switching contact elements can be moved together, between a closed position which corresponds to the switched-on state of the switching device, and an open position which corresponds to a switched-off state of the switching device. The individual current paths are each assigned two arc extinguishing devices in the form of extinguishing plates, arranged over one another and electrically isolated from each other. In addition, when the movable switching contact elements are open, each current path has two isolation gaps which form between the ends of the movable switching elements and the first and second fixed switching elements which are allotted to the ends of the movable switching contact elements. On opening of the switching contact elements, an arc which can be extinguished with the help of arc extinguishing devices is formed along isolation gaps. Since arcs in direct current applications cannot be extinguished during zero current passing as in alternating current applications, a magnetic field that drives the arc into an arc extinguishing device has to be used in direct current applications. This magnetic field is built up by permanent magnets, where a magnetic field is built up with field lines in a direction which runs transverse to the isolation gaps and creates a Lorenz force on the arcs that form along these separation sections which drives an arc in the direction of an arc extinguishing device. In this context, an arc between a first contact pair is driven in the direction of a first arc extinguishing device and the arc between a second contact pair is driven in the direction of the second arc extinguishing device. Since the movement of the arcs is dependent on the direction of the current, the switching device is only suitable for one current direction, i.e. polarity. If the switching device is operated in the opposite current direction, the arcs will not be driven into the arc extinguishing devices but in the opposite direction.

### SUMMARY

An aspect of the invention provides a switching device for direct current operation, the device comprising: a housing; a contact pair including a first contact and a second contact, at least one of the two contacts being movable, and the two contacts being in contact with each other in a switched-on state of the switching device and not in contact with each other in a switched-off state of the switching device; an arc driver assembly configured to generate a magnetic field at least in an area of the contact pair; a first arc guiding arrangement configured to drive a first arc, generated between the contacts upon a first direction of current, to a first extinguishing device configured to extinguish the first arc; and a second arc guiding arrangement configured to drive a second arc, generated between the contacts upon a second direction of current, opposite to the first direction of current, to a second extinguishing device configured to extinguish the second arc, wherein each arc guiding arrangement includes a first guide plate and a second guide plate, wherein at least the first guide plate is fixed in an unmovable position in the housing, wherein the second guide plate is split, including a first part and a second part of the second guide plate, wherein each first part of the second guide plate is connected securely by a bridge arrangement, and is installed in a movable position in the housing, and wherein each second part of the second guide plate is fixed in a fixed position in the housing.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a longitudinal section view of the housing of a switching device in accordance with this invention;

FIG. 2 The switching device according to FIG. 1, without a housing; and

FIG. 3 An arc driver assembly with a permanent magnet and pole plates.

### DETAILED DESCRIPTION

An aspect of this invention provides a switching device that can be operated independent of polarity and it can be used in case of different directions of current.

An aspect of the invention provides a switching device for direct current operation comprising a housing, at least one contact pair made up of a first contact and a second contact, where at least one of the contacts is movable and the two contacts are in contact with each other in the switched-on state of the switching device and are not in contact in the switched-off state of the switching device, further comprising an arc driver assembly, which generates a magnetic field at least in the region of the contact pair, and a first arc guiding arrangement, which guides an arc produced between the contacts in the first direction of current to a first extinguishing device for extinguishing the arc. According to the invention, there is a second arc driver arrangement and an arc produced between the contacts in case of the second direction of current opposite to the first direction of current is driven to a second extinguishing device for extinguishing the arc and where both arc guiding arrangements are fixed in an unmovable position in the switching housing.

A further aspect of the invention provides a switching device for direct current operation comprising a housing, at least one contact pair made up of a first contact and a second contact, where at least one of the contacts is movable and the two contacts are in contact with each other in the switched-on state of the switching device and are not in contact in the switched-off state of the switching device, further comprising an arc driver assembly, which generates a magnetic field at least in the region of the contact pair, and an arc produced between the contacts is guided by an arc guiding arrangement in case of the first direction of current to a extinguishing device for extinguishing the arc.

This ensures that the arc which can form at a contact pair is driven in one of the two extinguishing devices independent of the direction of current. The arrangement of the extinguishing devices installed in a fixed position in the housing ensures that these can be more simple. The two extinguishing devices can have a similar or identical structure. The extinguishing devices can have a similar structure due to the fact that identical extinguishing plates can be used in the two extinguishing devices if using a deionizing extinguishing chamber fitted with several extinguishing plates.

The first arc guiding arrangement can be arranged in such a manner that an arc with a first direction of current is diverted in a first direction and guided to a first extinguishing device; and that the second arc guiding arrangement is arranged in such a manner that an arc with a second direction of current is diverted in a second direction parallel to the first direction and it is driven to a second extinguishing device. The arcs in case of both directions of current are consequently driven in the same direction by the respective extinguishing devices. The extinguishing devices are thus aligned in the same direction. This provides a simple and compact arrangement of the two extinguishing devices and these can be preferably arranged right next to each other. The extinguishing devices are preferably located at the housing wall, where each extinguishing device has a discharge opening pointing in the same direction and they are aligned with the openings of the housing.

The first contact is located preferably on the upper side of a fixed contact support which is installed in a fixed position in the housing. The arc guiding arrangements are arranged preferably in such a manner that an arc with a first direction of current is driven along the upper side of the fixed contact support to a first extinguishing device and an arc with a second direction of current is driven along the lower side opposite to the upper side of the fixed contact support to a second extinguishing device. The arc with a second direction of current is diverted by 180° compared to the route of travel of the arc in case of the first direction of current.

The fixed contact support stretches preferably between the two extinguishing devices. This ensures a compact and symmetrical structure, where the two extinguishing devices are separated by the fixed contact support; and there is no need for further separating plates.

The arc guiding arrangements comprise a first guide plate and a second guide plate for guiding the arcs, where the first guide plate stretches from the first contact to the respective extinguishing device and the second guide plate stretches from the second contact to the respective extinguishing device. Thus an arc formed between the two contacts is maintained between the two guide plates and a magnetic field can drive the arc between these two guide plates in the direction of the respective extinguishing device.

The arc guiding arrangement can have a very compact structure if the first guide plate is made up of a fixed contact support fixed in an unmovable position in the housing and the first contact is arranged on the guide plate. The fixed contact support serves also as the point of connection with an electrical conductor, and therefore the fixed contact support has the same potential as the first contact.

The second guide plate can be arranged on a bridge arrangement, which is movable as compared to the first contact and it holds the second contact. Thus the second guide plate has the same potential as the second contact.

The second guide plate can be split and it can have a first part connected to the bridge arrangement which is movable as compared to the first contact, and a second part which is arranged in the contact housing in a fixed position.

Basically the two guide plates must be arranged to ensure that the distance increases between the two guide plates starting from the contacts and leading to the respective extinguishing device to increase the voltage for maintaining an arc between the two guide plates. The two guide plates surround the extinguishing device to ensure that the arcs are finally driven into the extinguishing device.

The two extinguishing devices can have an identical structure to ensure a simple structure of the switching device using standardized components. The extinguishing devices can be deionizing extinguishing chambers with a multitude of extinguishing plates electrically isolated from each other.

The arc guiding arrangements can comprise at least one permanent magnet which is arranged between two pole plates, where the contact pair is arranged between the pole plates. The arrangement of the pole plates ensures that a homogeneous magnetic field is generated in a large area. Alternatively there can be two permanent magnets located opposite to each other; and thus the pole plates are not required.

The switching device can be designed as a double interrupting switching device, fitted with two contact pairs forming a double interrupting switching arrangement with a first contact and a second contact, where the second contacts are arranged on a bridging contact member which can be moved to the first contacts. In the switched-on state of the circuit breaker the second contacts are in contact with the first contacts, where the bridging contact member provides the electrical connection between the second contacts. This means that the two contact pairs are connected in series.

The arc guiding arrangements can be arranged for both contact pairs in mirror on opposite sides of the bridging contact member.

Moreover, there can be several double interruption switching arrangements arranged next to each other, whereby the bridging contact members of the different switching arrangements are actuated by a common switching bridge to provide a multi-pole switching device.

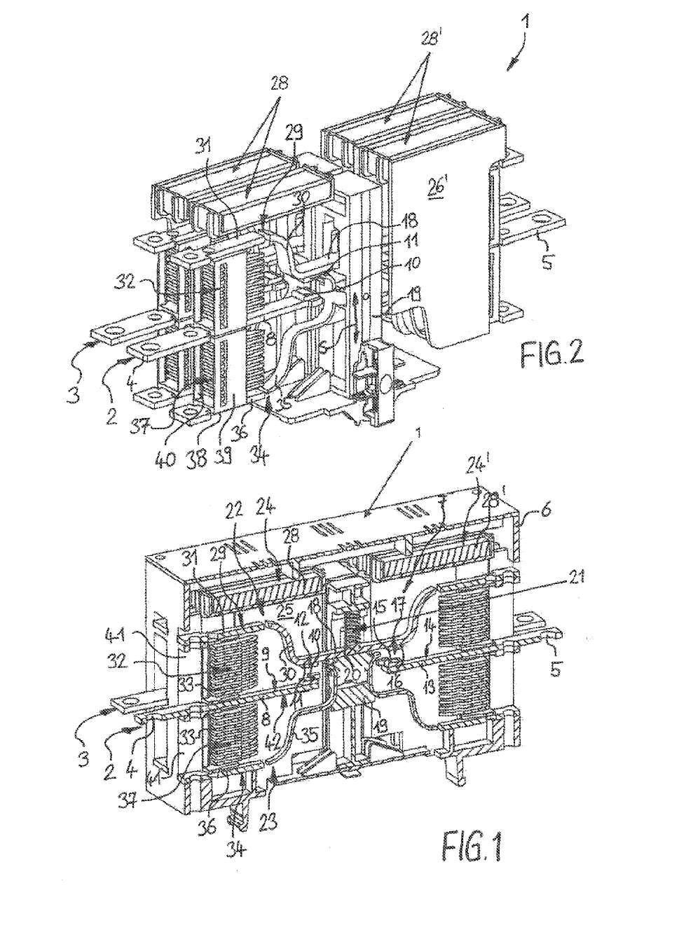

FIGS. 1 and 2 show the switching device 1 according to this invention in perspective view with an identical viewing angle, however, the housing is not included in FIG. 2 for reasons of clarity. FIGS. 1 and 2 are presented jointly below.

The electrical switching device 1 comprises a total of two poles, i.e. two switching paths, that is, a first switching path 2 and a second switching path 3. Both the switching paths 2, 3 are each provided with a circuit breaker, as described in detail below, and can thus be electrically cut off. Both switching paths 2, 3 can each be integrated into a direct current circuit and can be used to interrupt the current flow. The front switching path 2 presented in FIGS. 1 and 2 shall be described in detail below also representative of the second switching path 3, because both switching paths 2, 3 have an identical structure.

FIG. 2 shows a housing 6 of the switching device 1, having a switching chamber 7 each for switching path 2, 3, and the circuit breaker is arranged in the housing for each switching path 2, 3. The first switching path 2 comprises a first connection 4 and a second connection 5 for the purpose of connecting the first current path 2 with the terminals of a direct current circuit. The first connection 4 is a component of a first fixed contact support 8 leading into the switching chamber 7, where the first connection 4 protrudes from the housing 6. The fixed contact support 8 holds a first contact 10 on its upper side 9, and the first contact 10 can be connected with and disconnected from the second contact 11, which is arranged in a movable position as compared to the first contact. The first contact 10 and the second contact 11 make up the first contact pair 12.

There is a second fixed contact support 13 arranged mirrored to the first fixed contact support 8; and this second fixed contact support makes up the second connection 5. The second fixed contact support 13 leads also into the switching chamber 7, where the second fixed contact support 13 with the second connection 4 protrudes from the housing 6. The second fixed contact support 13 holds an additional first contact 15 on its upper side 14. An additional second contact 16 is arranged in a movable position as compared to the first contact 15, where the first contact 15 and the second contact 16 can be connected or disconnected; and together they make up a second contact pair 17.

The two second contacts 11, 16 are arranged on an electrically conductive bridging contact member 18; and they are electrically connected to each other. The bridging contact member 18 can be shifted vertically between a raised position and a lowered position in case of the orientation of the switching device 1 presented in FIGS. 1 and 2, where the switching device 1 is switched off in the raised position because the second contacts 11, 16 are not in contact with the first contacts 10, 15. When the bridging contact member 18 is lowered, the second contacts 11, 16 are in contact with the first contacts 10, 15, and this position corresponds with the switched-on state of the switching device. Electrical current flows between the first connection 4 and the second connection 5 in the switched-on state of the switching device 1. The flow of electrical current between the first connection 4 and the second connection 5 is interrupted in the switched-off state.

There is a switching bridge 19 designed for shifting the bridging contact member 18, arranged in the housing 6 in a vertically movable position, and which supports both the bridging contact member 18 of the first switching path 2 and the bridging contact member of the second switching path 3 for the synchronous switching of the two switching paths 2, 3.

The bridging contact member 18 is fixed within the switching bridge 19 in a vertically movable position, where the bridging contact member 18 in the raised position, as presented in FIGS. 1 and 2, is pressed by a spring 21 acting in the vertical direction against a stopper 20 of the switching bridge 19. The two contacts 11, 16 are contacted with the first contacts 10, 15 when the switching bridge 19 is moved in the lower position; and the bridging contact member 18 is pressed against the fixed contact support 8, 13. The switching bridge 19 is moved a bit further down vertically in this position, where the bridging contact member 18 is raised from the stopper 20 against the force of the spring 21 until the switching bridge 19 reaches the lowest position. Thus the bridging contact member 18 is pressed against the fixed contact support 8, 13 by a specific spring force of the spring 21.

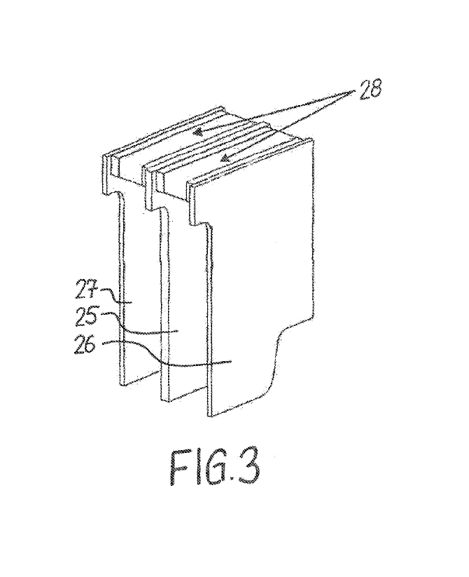

We shall present the first switch arrangement of the first contact pair 12 in detail below; and this is designed as an identical mirror structure of the second switch arrangement of the second contact pair 17. There is a first arc guiding arrangement 22 and a second arc guiding arrangement 23 arranged in the area of the first contact pair 12. The two arc guiding arrangements 22, 23 are arranged vertically above each other. There is an additional arc driver assembly 24 presented in detail in FIG. 3. The arc driver assembly 24 comprises two permanent magnets 28 arranged between the two pole plates 25, 26, 27. Thus there are a total of 3 pole plates, that is a middle pole plate 25 between the two permanent magnets 28 and a first exterior pole plate 26 and a second exterior pole plate 27. The permanent magnets 28 are located above the two arc guiding arrangement 22, 23, where the pole plates 25, 26, 27 reach down vertically and run around the switching chamber 7 of the two switching paths 2, 3. The pole plates 25, 26, 27 are arranged in the area of the two first contact pairs 12 of the two switching paths 2, 3; and they cover the entire area of the two arc guiding arrangements 22, 23. This arrangement of the permanent magnets 28 and the pole plates 25, 26, 27 ensures that there is a homogeneous magnetic field generated between the pole plates 25, 26, 27 running perpendicular to the pole plates and the field lines run transverse to the direction of movement of the bridging contact member 18. Thus the field lines of the magnetic field generated by the arc driver assembly 24 also run transverse to the arc which can form between the first contact 10 and a second contact 11. There is a Lorenz force generated in this manner acting on the arc and driving the arc in a specific direction depending on the direction of the magnetic field and the direction of current of the arc. If the magnetic field is generated from the second outer pole plate 27 not presented in FIG. 1 to the middle pole plate 25 and the current flows from the first connection 4 to the second connection 5, this would generate an arc at the first contact pair 12 in a vertical direction from bottom to top. The arc would be driven in this manner to the left in FIG. 1. An arc with the opposite direction of current, that is from the second contact 11 vertically down to the first contact 10 would be driven first to the right and then diverted as presented below.

There are the two arc guiding arrangements 22, 23 installed to drive the arcs generated in a specific direction. The first arc guiding arrangement 22 surrounds a first guide plate, which is represented in this case by the first fixed contact support 8. It is also possible, however, that there is a separate guide plate installed for this purpose. Additionally there is a second split guide plate 29 consisting of two parts. A first part 30 of the second guide plate 29 is shaped as a single piece together with bridging contact member 18. A second part 31 of the second guide plate 29 is fixed in an unmovable position at housing 6. Both parts 30, 31 of the second guide plate 29 overlap and they have a small air gap at their junction.

The first guide plate shaped as the first fixed contact support 8 stretches from the first contact 10 to the first extinguishing device 32. The second guide plate 29 stretches from the second contact 11 also to the first extinguishing device 32. Thereby the two guide plates 8, 29 are shaped in such a manner that they comprise the first extinguishing device 32 at their ends opposite to the contacts 10, 11. Furthermore, the two guide plates 8, 29 are shaped that the distance between the two guide plates 8, 29 increases starting from the first contact pair 12 in the direction of the first extinguishing device 32. This ensures that the voltage required to maintain the arc in the direction of the first extinguishing device 32 increases.

The burning time of the arc determines the switching time of the switching device 1, because the current flow is maintained between the contacts 11, 12. Furthermore the arc releases a large amount of heat which can cause the thermal destruction of the contacts 11, 12. It is therefore necessary to extinguish the arcs as quickly as possible by the arc guiding arrangements 22, 23 and the extinguishing devices 32, 37. The first extinguishing device 32 is a deionizing extinguishing chamber just as all other extinguishing devices, comprising a number of extinguishing plates 23 arranged in parallel to each other and electrically isolated from each other. When the arc is driven in the first extinguishing device 32, several partial arcs form between the different extinguishing plates 33; whereby the arc voltage is higher than the driving voltage and the arcs are extinguished safely.

The second arc guiding arrangement 23 is arranged on the lower side 42 of the first fixed contact support 8 which is opposite to the upper side 9 of the fixed contact support 8. It comprises a first guide plate, made up also by the first fixed contact support 8, and a second guide plate 34, split in a first part 35 and a second part 36. The first part 35 of the second guide plate 34 is fixed to the switching bridge 19 and thus they move together with the bridging contact member 18. The second part 36 of the second guide plate 34 is fixed in a unmovable position at housing 6. The second guide plate 34 stretches similar to the second guide plate 29 of the first arc guiding arrangement 22 from the second contact 11 in the direction of a second extinguishing device 37. The second extinguishing device 37 has an identical structure as the first extinguishing device 32 and it is arranged on the lower side 42 of the first fixed contact support 8. The fixed contact support 8 stretches between the two extinguishing devices 32, 37. The second extinguishing device 37 has an identical structure as the first extinguishing device 32, thus reference is made hereby to the description of the first extinguishing device 32.

The second guide plate 34 stretches from the second contact 11 in a vertical direction downwards at first and thus it stretches from the upper side 9 of the first fixed contact support 8 to the lower side 42 thereof. At the lower side 42 the second guide plate 34 stretches further horizontally in the direction of the second extinguishing device 37. Then it stretches further diagonally downwards to the end, and it encloses the second extinguishing device 37 together with the first fixed contact support 8. In case of a second direction of current of the arc generated between the first contact 10 and the second contact 11, the above set-up ensures that the arc is driven to the right and it is first diverted downwards by the section of the second guide plate 34 stretching vertically downwards, and it is further diverted in the horizontal part of the second guide plate 34 and therefore the arc is thus driven away from the switching bridge 19 in the direction of the extinguishing device 37. The arc with a second direction of current is finally driven in the direction of the second extinguishing device 37 which is parallel to the direction where the arc with a first direction of current is driven into the first extinguishing device 32. Thus independent of the direction of current of the first switching path 2, the arc formed is driven away from the switching bridge 9 in the direction of the respective extinguishing device 32, 37 to avoid generating thermal load on the switching bridge 19.

The arc guiding arrangements and the arc driver assemblies of the second contact pair 17 are arranged in a mirrored structure. In case of a first direction of current between the first connection 4 and the second connection 5, the direction of current of the arc between the contacts 10, 11 of the first contact pair 12 is directed in an opposite direction in space as compared to the arc between the contacts 15, 16 of the second contact pair 17. If current flows from the first contact 4 to the second contact 5, an arc is formed at the first contact pair 12 from the first contact 10 to the second contact 11 with a direction of current vertically upwards. An arc is formed at the second contact pair 17 in the direction of the second contact 16 to the first contact 15 vertically downwards. To ensure that both arcs are driven in the respective first extinguishing device 32 in case of the same direction of current between the first connection 4 and the second connection 5, the magnetic field of the arc driver assembly 24 at the first contact pair 12 must be set up in the opposite direction as in case of the second contact pair 17. It should be noted that it is desirable in principle that both arcs at the two contact pairs 12, 17 are driven in the first extinguishing device 32 in case of the first direction of current; and to the second extinguishing device 37 in case of the second direction of current; to ensure that the arcs of the two contact pairs 12, 17 travel the same route until they reach the respective extinguishing device, and thus the two arcs are extinguished preferably at the same time.

FIG. 2 shows the respective extinguishing devices, where all extinguishing devices have the same structure and the second extinguishing device 37 is hereby presented in more detail as an example. This comprises a frame 38 with walls 39 made of an non-conductive material; and the different extinguishing plates 33 are fixed to this frame. The extinguishing devices have discharge openings 40 in the direction opposite to the switching bridge 19, and these openings are in level with the opening of the housing 41 of the housing 6.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### REFERENCE LIST

1 Switching device
2 First switching path
3 Second switching path
4 First connection
5 Second connection
6 Housing
7 Switching chamber
8 First fixed contact support
9 Upper side
10 First contact
11 Second contact
12 First contact pair
13 Second fixed contact support
14 Upper side
15 First contact
16 Second contact
17 Second contact pair
18 Bridging contact member
19 Switching bridge
20 Stopper
21 Spring
22 First arc guiding arrangement
23 Second arc guiding arrangement
24 Arc driver assembly
25 Middle pole plate
26 First exterior pole plate
27 Second exterior pole plate
28 Permanent magnet
29 Second guide plate
30 First part of the second guide plate
31 Second part of the second guide plate
32 First extinguishing device
33 Extinguishing plate
34 Second guide plate
35 First part of the second guide plate
36 Second part of the second guide plate
37 Second extinguishing device
38 Frame
39 Wall
40 Discharge opening
41 Housing opening
42 Lower side
S Switching direction

1. A switching device for direct current operation, the device comprising:
a housing;
a contact pair including a first contact and a second contact, at least one of the two contacts being movable, and the two contacts being in contact with each other in a switched-on state of the switching device and not in contact with each other in a switched-off state of the switching device;
an arc driver assembly configured to generate a magnetic field at least in an area of the contact pair;
a first arc guiding arrangement configured to drive a first arc, generated between the contacts upon a first direction of current, to a first extinguishing device configured to extinguish the first arc; and
a second arc guiding arrangement configured to drive a second arc, generated between the contacts upon a second direction of current, opposite to the first direction of current, to a second extinguishing device configured to extinguish the second arc,
wherein each arc guiding arrangement includes a first guide plate and a second guide plate,
wherein at least the first guide plate is fixed in an unmovable position in the housing,
wherein the second guide plate is split, including a first part and a second part of the second guide plate,
wherein each first part of the second guide plate is connected securely by a bridge arrangement, and is installed in a movable position in the housing, and
wherein each second part of the second guide plate is fixed in a fixed position in the housing.

2. The device of claim 1, wherein the first arc guiding arrangement is arranged in such a manner that the first arc is diverted in the first direction and guided to the first extinguishing device and the second arc guiding arrangement is arranged in such a manner that the second arc is diverted in the second direction parallel to the first direction, and
wherein the second arc is driven to the second extinguishing device.

3. The device of claim 1, wherein the first contact is arranged on an upper side of a fixed contact support, the fixed contact support being fixed in an unmovable position in the housing,
wherein the first arc is driven along the upper side of the fixed contact support to the first extinguishing device, and
wherein the second arc is driven along a lower side, opposite to the upper side, of the fixed contact support, to the second extinguishing device.

4. The device of claim 3, wherein a fixed contact support stretches between the two extinguishing devices.

5. The device of claim 1, wherein the first guide plate runs from the first contact to a respective extinguishing device, and
wherein the second guide plate runs from the second contact to the respective extinguishing device.

6. The device of claim 5, wherein the first guide plate includes a fixed contact support fixed in an unmovable position in the housing, and
wherein the first contact is arranged on the first guide plate.

7. The device of claim 5, wherein the second guide plate, which is movable as compared to the first contact, is arranged on the bridge arrangement, and
wherein the second contact is arranged on the bridge arrangement.

8. (canceled)

9. The device of claim 5, wherein a distance between the two guide plates increases starting from the first and second contacts to a respective extinguishing device, and
wherein both guide plates surround the extinguishing device.

10. The device of claim 1, wherein the two extinguishing devices have the same structure.

11. The device of claim 1, wherein the extinguishing devices are deionizing extinguishing chambers including a multitude of extinguishing plates which are isolated from each other.

12. The device of claim 1, wherein the first and second arc guiding arrangement each include a permanent magnet,
wherein the permanent magnet is arranged between two pole plates, and
wherein the contact pair is arranged between the pole plates.

13. The device of claim 1, comprising two contact pairs, which make up a double interrupting switching arrangement together with a first contact and a second contact,
wherein the two second contacts are arranged on a bridging contact member which is movable as compared to the first contacts,
wherein, in the switched-on state of the switching device, the second contacts are respectively in contact with the first contacts, and
wherein the bridging contact member creates a conductive connection between the two second contacts.

14. (canceled)

15. The device of claim 1, comprising several double interruption switching arrangements arranged next to each other,
wherein bridging contact members of the different switching arrangements are actuated by a common switching bridge.

16. The device of claim 1, wherein the extinguishing devices are deionizing extinguishing chambers including two or more extinguishing plates which are isolated from each other.
